(19) United States
(12) Patent Application Publication
(10) Pub. No.: US 2023/0302841 A1
(43) Pub. Date: Sep. 28, 2023

(54) Folding Panoramic Postcard

(71) Applicant: Peter George Weyand, Kingston, NY (US)

(72) Inventor: Peter George Weyand, Kingston, NY (US)

(21) Appl. No.: 17/655,933

(22) Filed: Mar. 22, 2022

(51) Int. Cl. B42D 15/08; G09F 1/04

(52) U.S. Cl. CPC B42D 15/08; G09F 1/04

(57) ABSTRACT

A folding postcard has a panoramic image imprinted on a first face of a quadrate print material. It is divided into image segment panels with scorings to facilitate folding image panels upon themselves to create a mailable or shippable package. The dimensions of the image segment panels are set such a first and third image segment panel allows the folded panoramic image to be folded and sealed with an adhesive postage token or stamp. The length of the first image segment panel is reduced by a fractional amount. The length of the first image segment panels is equal to the length of the average length of the image segment panels. The remaining segment panels are each decreased by a small percentage of the previous image segment panel to ensure that the folding postcard is folded and each image segment panel is folded relatively flat.

### TECHNICAL FIELD

This disclosure relates generally to a folding postcard with multiple image segment panels structured for folding the postcard to adhere to postal mailing requirements and provide a sealing method using applicable postage tokens or stamps.

### BACKGROUND

“Rare Postcards Reveal Early 20th Century Panoramas”, by Allison Meier, May 13, 2013, found Jan. 10, 2022, https://hyperallergic.com/70938/ illustrates panoramic postcards locations throughout the world in a wide frame. Usually folding for more compact delivery, these broad little views offered expansive looks at landscapes and accommodated views of the world, such as panoramic views of mountains, deserts, and wild areas of the world as well as skyscrapers or massive sea vessels.” FIGS. 1A and 1B are diagrams of front and rear views of a folding postcard 5 of the prior art that demonstrate a panoramic view 10 of a New York City skyline. A creased area 20 shows where the postcard 5 would be folded. The backside areas shown in FIG. 1B show an area for putting a message 25a and an area for an address 25b. The fold crease would be such that the front side illustration 10 is folded on the interior of the folded postcard 5. An adhesive tape 30 is adhered to the opposite edges of the folded postcard 5 at location 30.

FIG. 1C is a side view diagram of an unfolded postcard 5 of FIGS. 1A and 1B. The front side illustration 10 is shown as an exaggeration of the thickness of the panoramic image imprinted on a print material such as heavyweight paper or thin cardboard. The crease 20 is essentially a “paperboard hinge” formed via compression along line 20 of FIGS. 1A and 1B where the fold will occur. The compression makes a depression on one side of the quadrate print material and a bump on the opposite side of the quadrate print material and does not break through the quadrate print material. FIG. 1D is a diagram of a folded postcard of FIGS. 1A and 1B. The folding placed the front side of the illustration 10 inside the fold and the quadrate print material 15. The backside of the quadrate print material is now available for a message, an address, and the necessary postage. The two ends of the postcard are now placed such that the adhesive tape 30 can secure the postcard for transportation.

As described in FIGS. 1A, 1B, 1C, and 1D, the folding postcards were creased 20 to allow the folding in the center. “Creasing and Scoring,” Accessed on: Feb. 2, 2022, online at https://www.metapaper.io/en/wiki/creasing-and-scoring/detail/, copyright 2022 by Metapaper GmbH Stuttgart, Stuttgart, Germany describes creasing and scoring as folding paper or cardboard without fold cracking, particularly when working with thicker papers. Creasing creates a bendable zone by shaping the paper or cardboard. The paper is displaced downwards across the crease, creating a kind of bulge. When the card is folded, this bulge bends inwards. The crease must be such that the paper can be folded at an angle of 90 degrees or 180 degrees without fold cracking.

As noted in “Creasing and Scoring,” scoring is also used to create a bending point for optimum folding of paper or cardboard. However, scoring does not reshape the material. Material is taken off at the score, thus reducing the thickness by removing a wedge-shaped strip of rectangular paper or a cardboard chip.

### SUMMARY

An object of this disclosure is to provide a folding postcard having a panoramic image imprinted on a first face of a quadrate print material. The quadrate print material is chosen from print materials, including heavyweight paper, cardboard, plastic, metal, wood, or other suitable material. The postcard is divided into image segment panels that have scorings for facilitating folding image panels upon themselves to create a mailable or shippable package from the panoramic image imprinted on the quadrate print material.

Another object of this disclosure is to provide a method to determine the dimensions of image segment panels imprinted on the quadrate print material such that a first and third image segment panel allows the folded panoramic image imprinted on the quadrate print material to be folded and sealed with an adhesive postage token or stamp. The length of the first image segment panel is reduced by a fractional amount determined by the area to adhere to an adhesive postage token or stamp. The length of a second image segment is equal to the average length of the image segment panels. The length of the remaining image segment panels is decreased by a fractional amount to ensure that the folding postcard is folded and each of the image segment panels is folded relatively flat.

To accomplish at least one of these objects, a number of the image segment panels is chosen such that the size of the folded quadrate print material with the affixed panoramic image meets the requirements of the mode of transportation to be used. The aspect ratio of a master panoramic image and the chosen length of the postcard determines the width of each image segment panel. The average length of the image segment panels is determined as the chosen length of the folding postcard divided by a chosen number of the image segment panels. The length of the first image segment panel from the first end of the panoramic postcard is determined as the average length of the image segment panels decreased by a fractional amount determined by an area necessary to adhere the postage token or stamp.

The fixed percentage for determining the length of the first image segment panel provides sufficient area to allow the adhesive postage token or stamp to adhere sufficiently to the first image segment panel and a third image segment panel. The length of the second image segment panel is set to be the average length of the image segment panels.

The lengths of the third image segment panel through the last image segment panel at a second end of the quadrate sheet with the affixed panoramic image are determined as the length of the previous image segment panel decreased by a small percentage.

A scoring mark is placed at a boundary between each image panel. The scoring mark permits each panel to fold precisely. Once the panoramic image imprinted on the quadrate print material is folded, the first and third image panels receive an adhesive postage token or stamp to seal the folded panoramic image imprinted on the quadrate print material for transportation.

### BRIEF DESCRIPTION OF THE DRAWINGS

FIGS. 1A and 1B are diagrams of front and rear views of a folding postcard of the prior art.

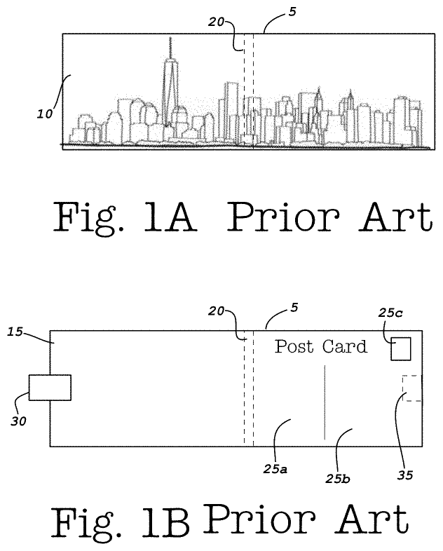

FIG. 1C is a side view diagram of an unfolded postcard of FIGS. 1A and 1B.

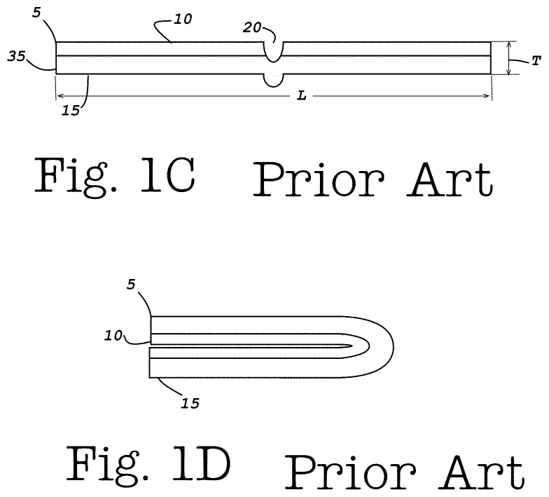

FIG. 1D is a diagram of a folded postcard of FIGS. 1A and 1B.

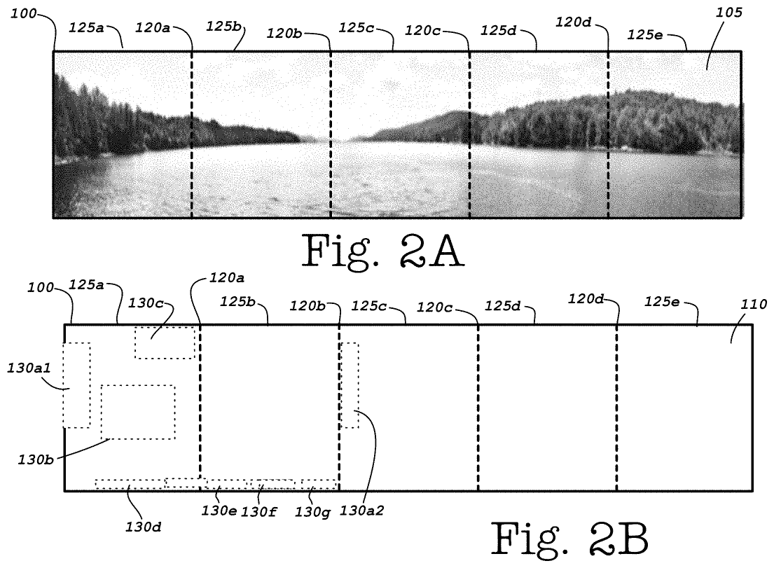

FIGS. 2A and 2B are diagrams of front and rear views of a folding postcard embodying the principles of the present disclosure.

FIG. 2C is a diagram of a side view of an unfolded folding postcard embodying the principles of the present disclosure.

FIG. 3 is a diagram of multiple panoramic images imprinted upon a large section quadrate print material embodying the principles of the present disclosure.

FIGS. 4A, 4B, 4C, 4D, and 4E illustrate a process of folding the scored postcard embodying the principles of the present disclosure.

FIG. 5 is a flowchart illustrating forming a folding postcard embodying the principles of the present disclosure.

FIG. 6 is a flowchart illustrating determining a scoring pattern of the method of forming the folding postcard described in FIG. 5, embodying the principles of the present disclosure.

FIG. 7 is a table of an analysis of a structure of a folding postcard embodying the principles of the present disclosure.

### DETAILED DESCRIPTION

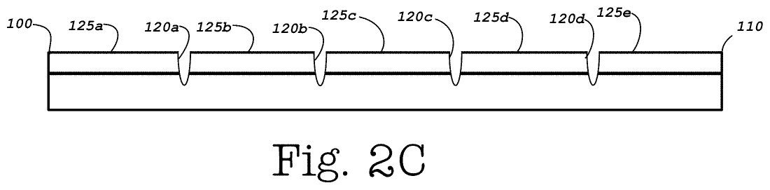

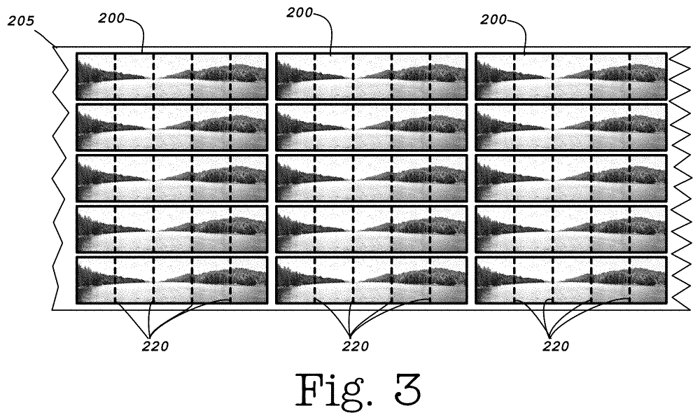

FIGS. 2A and 2B are diagrams of front and rear views of a folding postcard 100 embodying the principles of the present disclosure. A folding postcard 100 has an image 105 imprinted on a printing material 110, such as heavyweight paper or lightweight cardboard

The master image is formed by creating a single panoramic image covering an area's wide and unbroken view. Many modern digital cameras, such as a digital single-lens reflex camera, a smart cellular telephones, or the like, incorporate a panorama mode of operation. Alternately, a series of images with a standard camera aspect ratio can be created and stitched together with known photo manipulating software to form the panoramic image. The desired dimensions are chosen according to the aspect ratio of the panoramic image. One of the dimensions (height or length) is chosen, and the other dimension is calculated from the aspect ratio. The quadrate print material 110 is chosen from a group of print materials, including heavyweight paper, cardboard, plastic, metal, wood, or other suitable print material. One or multiple images are imprinted on the quadrate printing material. The number of image segment panels 125a-125e is determined by the desired size of the folded postcard 100. The scoring of the image is accomplished by a scoring machine that is available in the industry and known in the art. The printing material 110 with the imprinted image 105 is divided into image panels 125a-125e. The boundaries between the image panels 125a-125e are scored 120a-120d by the scoring machine to permit the folding of the postcard 100. The first image segment panel 125a has an area 130a1, and the third image segment panel 125c has an area 130a2 that receives a postage token or stamp or stamp when the postcard is folded.

The backside of the first image segment panel 125a has a receiving address area 130b and a return address area 130c. The backside of the second image segment panel 125b is allocated for a manufacturer identifier 130e, a product barcode 130f, and a scene title 130g. The remaining image panels 125d and 125e are available for a private message from a sending person to a receiving person. While the manufacturer identifier 130e, the product barcode 130f, and the scene title 130g are described as being allocated to the second image segment panel 125b, any of the image segment panels 125 may have any of the manufacturer identifier 130e, the product barcode 130f, and the scene title 130g an still be in keeping with the principles of the present disclosure

FIG. 2C is a diagram of a side view of an unfolded folding postcard 100 embodying the principles of the present disclosure. The image 105 is imprinted on the quadrate print material 110. The thickness of the image 105 is determined by the imprinting process and may be embedded into the surface of the printing material. The thickness of image 105, as shown, is illustrative for discussion. The scored indicia 120a-120d are formed by removing a portion of the score indicia 120a-120d to reduce the thickness of the quadrate print material 110 by removing a wedge-shaped or rectangular piece of paper or a cardboard chip.

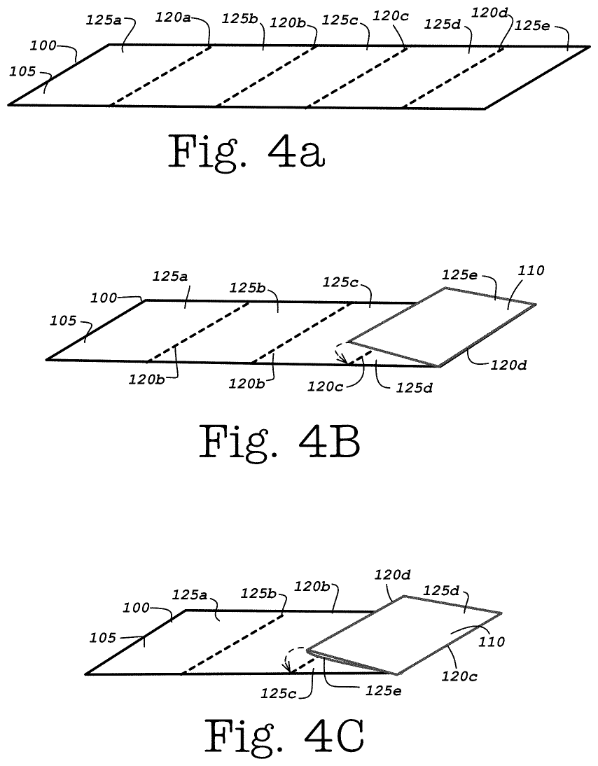

FIG. 3 is a diagram of multiple panoramic images 200 imprinted upon a quadrate print material 205 embodying the principles of the present disclosure. The images 205 may be printed on single larger sheets of heavyweight paper or lightweight cardboard or a continuous roll of the heavyweight paper or lightweight cardboard. The number of images 200 on the quadrate print material 205 is strictly dependent upon the print production process used for creating the folding panoramic postcards. The scoring indicia 220 are etched into the surface of the quadrate print material 205 imprinted with panoramic images 200.

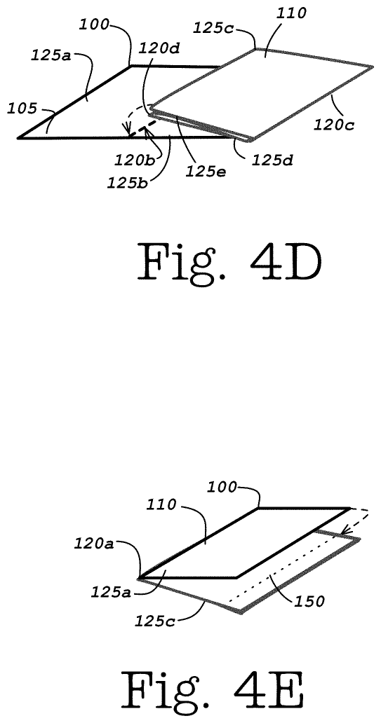

FIGS. 4A, 4B, 4C, 4D, and 4E illustrate a process of folding the scored postcard 100 embodying the principles of the present disclosure. The postcard 100, having a panoramic image 105 formed on printed material 110, is positioned to facilitate the folding of the postcard 100. The score indicia 120a-120d divide the panoramic image as imprinted upon the quadrate print material 110 into individual image panels 125a-125e, and permit trouble-free folding of the postcard 100.

In FIG. 4B, image segment panel 125e is the first image segment panel of the postcard to be folded. The image segment panel 125e is folded at the score indicium 120d to be placed on the image segment panel 125d. In FIG. 4C, the image segment panel 125d is the second image segment panel to be folded. The second folded image segment panel 125d and the first folded image segment panel 125e are folded at the score indicium 120c. The quadrate print material side 110 of the panel 125e is placed on the image side 105 of the panel 125d. Referring now to FIG. 4D, The image segment panel 125c and the folded image panels 125d and 125e are folded at the score indicium 120b such that the print side 110 of the image segment panel 125d is placed on the image side 105 of the image segment panel 125b. Referring to FIG. 4E, the final image segment panel 125a is folded at the score indicium 120a to cover the folded image cards 125b, 125c, and 125d. 125e illustrates the folded postcard 100 as being ready for sealing and transporting. The transporting will generally be through a national postal service. The final folded image card 125a has a width established such that when folded at the score indicium 120a, the opposite edge of the image card 125a is placed at location 150. Location 150 to allow a postage token or stamp or stamp to be placed on the image card 125a and image card 125c and seal the folding postcard 100. Be As shown in FIG. 2B, the first image segment panel 125a has an area 130a1, and the third image segment panel 125c has an area 130a2 that receives a postage token or stamp when the postcard is folded.

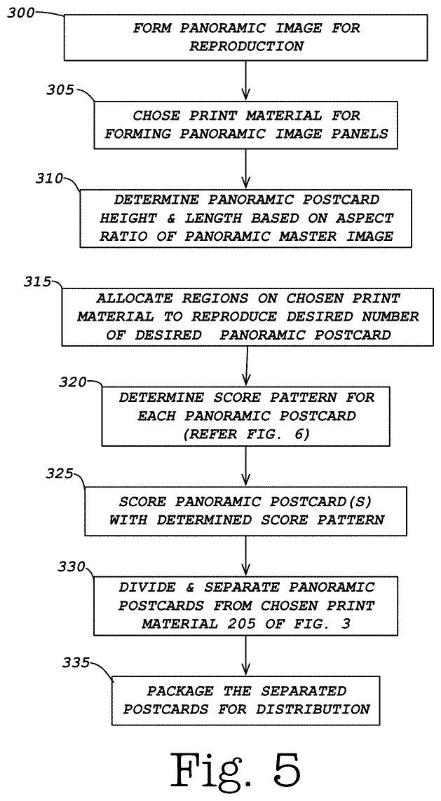

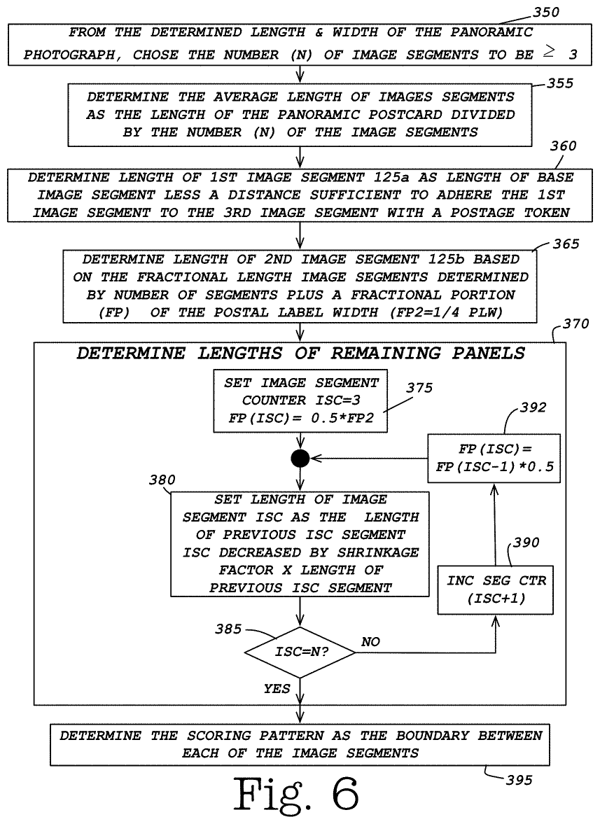

FIG. 5 is a flowchart illustrating forming a folding postcard embodying the principles of the present disclosure. A panoramic image is formed (Box 300) as a master image for reproduction. A print material is chosen (Box 305) from a heavyweight paper or cardboard suitable to meet the requirements for forming the folding postcard that meets the requirements of a postal authority such as the United States Post Office. The height and length of the quadrate print material are determined (Box 310) from an aspect ratio of the master image. Multiple regions are allocated (Box 315) for reproducing a desired number of the folding panoramic postcards. The scoring pattern for the folding postcard is determined (Box 320), as described in FIG. 6.

Referring to FIG. 6, the number N of the image segment panels is chosen (Box 350). The number of image segment panels for the folding postcard must be greater than or equal to three. An average length of each image segment panel is determined (BOX 355) by dividing the length of the panoramic postcard by the number N of the image segments.

Refer now to FIGS. 2A and 2B for the structure of image segment panels 125a-125e. The length of the first image segment panel 125a is chosen (Box 360) to equal the average length of the image segment panels less a distance sufficient to adhere the first image segment panel 125a to the third image segment 125C with a postage token or stamp. The difference between the length of the first image segment panel and the third image segment panel 125c permits the postage token or stamp to seal the folded panoramic postcard 100 for transportation through the mail.

The length of the first image segment panel 125a may be a first percentage less than the average length of the image segment panels 125a-125e. The first percentage is approximately 95% and is chosen to be dependent upon the area required of the first image segment panel 125a to receive a fraction of the width of the postal token or stamp. In the United States, a first-class stamp has a width of 0.870″ to 1.255″. The shrinkage of the first segment panel 125a would be approximately 0.5″ of the distance of the width of the chosen postal token or stamp.

The length of the second image segment panel 125b is determined (Box 365) to be the average length of the image segment panels 125a-125e.

The length of each of the remaining N image segment panels 125a-125e is determined (Box 370) by the following steps. An image segment counter ISC is set (Box (375) to the number of segment panels (N) less the number (2) for the first two segment panels. In this example, N=5, and therefore, the image segment counter is set to three (3). The third segment panel's 125c length is set (Box 380) to the average length of an image segment panel 125a-125e and decreased by a second shrinkage factor (approximately 1%). The image segment counter is tested (Box 385) If it equals the number (N) of image segment panels. If the image segment counter is not equal to the number of image segment panels 125a-125e, the image segment counter is incremented (Box 390). The current image segment panel 125c is set (Box 380) to be the average length of an image segment panel 125a-125e decreased by a second shrinkage factor (again approximately 1%). The image segment counter is again tested (Box 385). If it is equal to the number (N) of image segment panels, and when the image segment counter is equal to the number (N) of image segment panels, the determining (Box 379) image segment panel sizes are completed.

The scoring pattern 120a-120d is now determined (395) as being set at each boundary between adjoining image segment panels. Returning to FIG. 5, the Panoramic postcard 100 is scored (Box 325) with the determined scoring pattern. The panoramic postcards are now divided and separated (Box 330) by a cutting machine from the quadrate print material 205 (as shown in FIG. 3). The separated folding panoramic postcards 100 are packaged (Box 335) for shipment and distribution.

The scoring pattern 120a-120d for the image segment panels 125a-125e is defined (Box 310) to allocate regions on quadrate print material for the panoramic image panels 100.

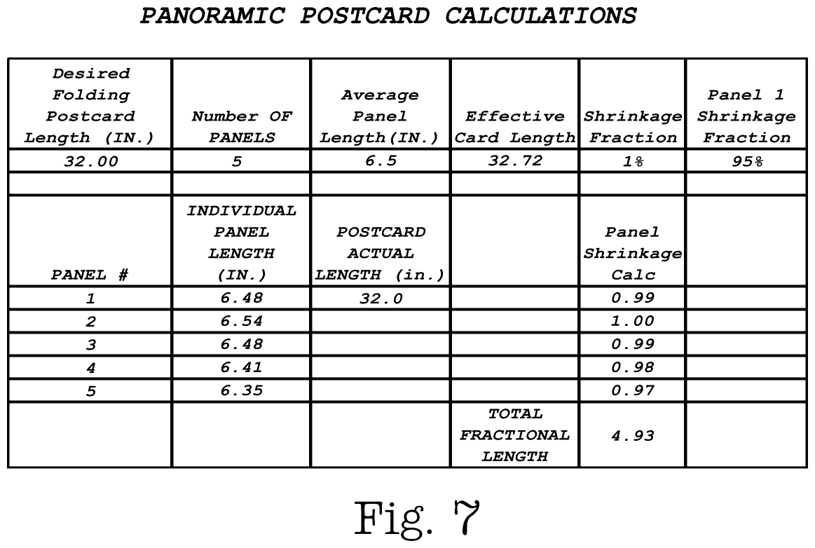

FIG. 7 is a table of calculations for the structure of a folding postcard embodying the principles of the present disclosure. Refer now to FIGS. 2A-2B and 7. The length of the folding postcard 100 is chosen to be 32″ with five (5) image segment panels 125a-125e. Which means that the average length of the image segment panels 125a-125e is 6.4″. The length of the first image segment panel 125a is chosen to be the average length of the image segment panels 125a-125e multiplied by the first shrinkage factor (95%).

The image segment panels are numbered from 1 to 5. As described above, the first panel is fixed at the average length of the image segment panels 125a-125e decreased by 5%. The second image segment panel 125b length is set to the average length of the image segment panels 125a-125e or 6.5″. The third image segment panel's 125c length is calculated to be the length of the second image segment panel 125b decreased by the second shrinkage factor of 1% to be 6.48. The fourth image segment panel's length 125d is calculated to be the length of the third image segment panel 125c decreased by the second shrinkage factor of 1% to be 6.41. The fifth image segment panel's length is calculated to be the length of the fourth image segment panel 125c decreased by the second shrinkage factor of 1% to be 6.35. The calculated image segment panel lengths are then summed together to determine the actual length of the folding panoramic postcard to be 32.0″ as chosen. As described above, the scoring lines will be at the boundaries of the image segment panels.

While this disclosure has been particularly shown and described with reference to the preferred embodiments thereof, it will be understood by those skilled in the art that various changes in form and details may be made without departing from the spirit and scope of the disclosure.

What is claimed is:

1. A foldable panoramic postcard comprising:
a quadrate print material sheet having a first side onto which a panoramic image is affixed and a second side onto which text is placed;
a plurality of scoring marks to demarcate the quadrate print material sheet with the affixed panoramic image into a plurality of image segment panels to allow the quadrate sheet with the affixed panoramic image to be folded such that a first segment and a third segment overlap to seal the folded quadrate sheet with the affixed panoramic image for transporting;
wherein an aspect ratio of a master panoramic image that forms the imprinted image on the quadrate print material and the chosen length of the postcard determines a width of the postcard;
wherein a number of the image segment panels is chosen;
wherein a length of the first image segment panel is an average length of the image segment panels reduced by a fractional amount to adhere the adhesive postage token or stamp;
wherein the first and the third image segment panels allow the folded panoramic image imprinted on the quadrate print material to be folded and sealed with an adhesive postage token or stamp;
wherein the length of the second image segment panel is set to be the average length of the image segment panels; and
wherein the length of the remaining image segment panels is determined by decreasing the length of a previous image segment panel by a small percentage to ensure that the folding postcard is folded and each of the image segment panels is folded relatively flat.

2. The foldable postcard of claim 1 wherein the quadrate print material is chosen from materials including heavyweight paper, cardboard, plastic, metal, wood, or other suitable material that will accept imprinting of the panoramic image.

3. The foldable postcard of claim 1 wherein an average image segment panel length is determined by dividing the length of the foldable postcard by a chosen number of the image segment panels.

4. The foldable postcard of claim 3 wherein a first image segment panel's length is determined by reducing the average image segment panel length by a fractional amount to allow the adhesive postage token or stamp to adhere to the first and third image segment panels.

5. The foldable postcard of claim 4 wherein the fractional amount of reduction of the first image segment panel is dependent upon the area required of the first image segment panel to receive a fraction of the width of the postal token or stamp of the average image segment panel length or approximately 5%.

6. The foldable postcard of claim 4 wherein the second image segment panel's length is the average image segment panel length.

7. The foldable postcard of claim 4 wherein subsequent image segment panel lengths are determined by reducing the previous image segment panel by approximately 1%.

8. The foldable postcard of claim 3 wherein scoring marks are placed at the boundaries between each image segment panel.

9. The foldable postcard of claim 8 wherein the scoring marks permit each image segment panel to fold flat.

10. The foldable postcard of claim 8 wherein the panoramic image imprinted on the quadrate print material is folded, and the first and third image segment panels receive an adhesive postage token or stamp to seal the folded panoramic image imprinted on the quadrate print material for transportation.

11. A method for manufacturing at least one foldable postcard comprises the steps of:
providing a quadrate print material sheet having a first side onto which at least one panoramic image is affixed and a second side available for accepting placement of text;
forming scoring marks into quadrate print material sheet with the at least one panoramic image to demarcate the at least one panoramic image into a plurality of image segment panels to allow the quadrate print material sheet with the affixed panoramic image to be folded such that a first segment and a third segment overlap to seal the folded quadrate print material sheet with the affixed panoramic image for transporting;
dividing the quadrate print material sheet to separate at least one panoramic image into at least one individual quadrate print material sheet partition with the panoramic image;
determining a width of the postcard from an aspect ratio of a master panoramic image that forms the imprinted image on the quadrate print material and the chosen length of the postcard;
reducing a length of the first image segment panel by a first fractional amount for adhering the adhesive postage token or stamp;
setting a length of the second image segment panel to approximately the average length of the image segment panels;
setting a length of the third image segment panels by decreasing the average length of the image segment panel by a second fractional amount to allow the folded panoramic image imprinted on the quadrate print material to be folded and sealed with an adhesive postage token or stamp; and
decreasing the length of the remaining image segment panels by a length of a previous image segment panel by a small percentage to ensure that the folding postcard is folded and each of the image segment panels is folded relatively flat.

12. The method for manufacturing at least one foldable postcard of claim 11 wherein the quadrate print material is chosen from materials including heavyweight paper, cardboard, plastic, metal, wood, or other suitable material that will accept imprinting of the panoramic image.

13. The method for manufacturing at least one foldable postcard of claim 11 further comprises the step of determining an average image segment panel length by dividing the length of the foldable postcard by a chosen number of the image segment panels.

14. The method for manufacturing at least one foldable postcard of claim 13 wherein the first fractional amount is dependent upon the width of the adhesive postage token or stamp or approximately 5%.

15. The method for manufacturing at least one foldable postcard of claim 14 wherein the second fractional amount is approximately 1%.

16. The method for manufacturing at least one foldable postcard of claim 13 further comprises the step of placing scoring marks at the boundaries between each image segment panel.

17. The method for manufacturing at least one foldable postcard of claim 16 wherein the scoring marks permit each image segment panel to fold flat.

18. The method for manufacturing at least one foldable postcard of claim 16 further comprises the step of imprinting the panoramic image on the quadrate print material that is folded and sealing the first and third image segment panels with an adhesive postage token or stamp to seal the folded panoramic image imprinted on the quadrate print material for transportation.
